(19) United States
(12) Patent Application Publication
(10) Pub. No.: US 2025/0353314 A1
(43) Pub. Date: Nov. 20, 2025

(54) RECORDING DEVICE

(71) Applicant: SEIKO EPSON CORPORATION, Tokyo (JP)

(72) Inventors: Motofumi OTANI, MATSUMOTO-SHI (JP); Yasumichi OKUDA, MATSUMOTO-SHI (JP)

(21) Appl. No.: 19/207,632

(22) Filed: May 14, 2025

(30) Foreign Application Priority Data
May 16, 2024 (JP) 2024-079980

(51) Int. Cl. B41J 15/16; B41J 15/04; B41J 29/13

(52) U.S. Cl. CPC B41J 15/16; B41J 15/04; B41J 29/13

(57) ABSTRACT

A recording device is provided with a feed out section for feeding out a medium from a roll body, a medium transport device for transporting the medium feed out in a transport direction from the feed out section, a recording section for recording on the medium transported by the medium transport device, and an exterior for housing the recording section and the medium transport device and also having a flat top surface section. The top surface section is provided with a positioning section on which a winding shaft for winding a medium can be placed, and in which a placement position of the winding shaft is determined by placing the winding shaft in contact therewith. An orthogonal mark is provided that indicates a direction that is orthogonal to an axial direction of the winding shaft positioned by the positioning section.

The present application is based on, and claims priority from JP Application Serial Number 2024-079980, filed May 16, 2024, the disclosure of which is hereby incorporated by reference herein in its entirety.

### BACKGROUND

### 1. Technical Field

The present disclosure relates to a recording device.

### 2. Related Art

An example of this type of apparatus is the recording device described in JP-A-2016-182716. JP-A-2016-182716 describes the following.

A roll paper set in a setting unit is fed out and supplied into a housing.

For example, a rewinding operation of the medium is sometimes performed in order to correct an initial winding deviation of a medium, such as a fabric, that is in a roll body state, or to change a paper tube of the roll body.

In this operation, one end of the medium is attached to the paper tube, which is placed in an unstable state, and then rewinding is started. However, when the user attaches the end of the medium to the paper tube, the uses attaches using visual measurements. This makes it difficult to attach the medium so that the axial direction of the paper tube and the direction of the side of the medium are orthogonal to each other. When the side of the medium is attached at an angle, the medium may meander while being wound around the paper tube, raising the concern that the side of the medium may not be aligned properly, resulting in unevenness.

JP-A-2016-182716 is a case where a rewinding operation of the medium around a paper tube, and there is no description considering the above concern.

### SUMMARY

In order to overcome the above problem, a recording device according to the present disclosure includes a feed out section configured to feed out a medium from a roll body; a medium transport device configured to transport, in a transport direction, the medium fed from the feed out section; a recording section configured to record on the medium transported by the medium transport device; and an exterior that houses the recording section and the medium transport device and that has a flat top surface section, wherein
the top surface section is configured to have placed thereon a winding shaft for winding the medium, includes a positioning section configured to determine a placement position of the winding shaft by the winding shaft being placed in contact with the positioning orthogonal mark section, and includes an indicating a direction orthogonal to an axial direction of the winding shaft positioned by the positioning section.

### BRIEF DESCRIPTION OF THE DRAWINGS

FIG. 1 is a perspective view of a recording device according to a first embodiment.

FIG. 2 is a schematic side view of the recording device of the first embodiment.

FIG. 3 is a plan view of the recording device of the first embodiment.

FIG. 4 is an enlarged plan view of a main part of the recording device of the first embodiment.

FIG. 5 is a perspective view of the recording device of the first embodiment.

FIG. 6 is a perspective view of a modification of the recording device of the first embodiment.

FIG. 7 is a view for explaining a rewinding operation of the recording device according to the first embodiment.

FIG. 8 is a diagram illustrating another rewinding operation of the recording device according to the first embodiment.

FIG. 9 is a perspective view of a recording device of a second embodiment.

### DESCRIPTION OF EMBODIMENTS

Hereinafter, the present disclosure will be first schematically described.

The recording device according to a first aspect of the present disclosure includes a feed out section configured to feed out a medium from a roll body; a medium transport device configured to transport, in a transport direction, the medium fed from the feed out section; a recording section configured to record on the medium transported by the medium transport device; and an exterior that houses the recording section and the medium transport device and that has a flat top surface section, wherein the top surface section is configured to have placed thereon a winding shaft for winding the medium, includes a positioning section configured to determine a placement position of the winding shaft by the winding shaft being placed in contact with the positioning section, and includes an orthogonal mark indicating a direction orthogonal to an axial direction of the winding shaft positioned by the positioning section.

Here, “flat” in “exterior having a flat top surface section” is used in the present specification in the meaning of being flat to the extent that a winding operation of winding the medium around the winding shaft can be performed in a state where the winding shaft is placed on the top surface section.

In this aspect, since the top surface section forming the exterior of the recording device has a configuration with the flat portion, the winding shaft for winding the medium can be placed thereon. By this, it is possible to perform the rewinding operation of the medium, such as to correct an initial winding deviation in a roll body state of the medium or to change a winding shaft of the roll body, by using the top surface section which forms a part of the exterior.

Further, the top surface section includes the positioning section for determining the placement position of the winding shaft by placing the winding shaft on the top surface section in contact with the positioning section. By this, by placing the winding shaft so as to be in contact with the positioning section when the winding shaft is placed on the top surface section, the winding shaft can be easily placed at a position where the rewinding operation of the medium is performed. Furthermore, since the winding shaft is placed on the top surface section in a state of being in contact with the positioning section, the position of the winding shaft during the rewinding operation of the medium is stabilized, and the rewinding operation is easily performed.

Furthermore, the recording device includes an orthogonal mark indicating a direction orthogonal to an axial direction of the winding shaft positioned by the positioning section. By this, when the tip end of the medium is attached and fixed to the winding shaft while the winding shaft is in a state of being positioned by the positioning section, the parallel state between the orthogonal mark and the side edge of the medium can be confirmed, and thus the fixing work can be easily performed in an appropriate state. Furthermore, when performing a rewinding operation on the medium by rotating the winding shaft after the fixing work, it is possible to perform the winding operation while adjusting the side edge of the medium to be parallel to the orthogonal mark, and thus it is possible to reduce a concern that the state of the edge of the medium after rewinding becomes irregular, that is, becomes uneven.

A recording device according to a second aspect of the present disclosure is an aspect according to the first aspect, wherein the orthogonal mark is provided on the top surface section.

According to the present aspect the orthogonal mark is provided on the top surface section. By this, when placing the winding shaft on the top surface section, the user can position the winding shaft by bringing it into contact with the positioning section while checking the orthogonal mark.

A recording device according to a third aspect of the present disclosure is an aspect according to the first aspect, wherein the orthogonal mark is provided on a sheet-shaped member and by the sheet-shaped member being placed at a placing position of the top surface section, the orthogonal mark becomes orthogonal to the axial direction of the winding shaft positioned by the positioning section.

According to this aspect, the orthogonal mark is provided on the sheet-shaped member, not provided directly on the top surface section. Further, by placing the sheet-shaped member at the placing position of the top surface section, the orthogonal mark becomes orthogonal to the axial direction of the winding shaft that is positioned by the positioning section. By this, the orthogonal mark becomes present on the top surface section only when the winding operation is performed, and in other cases, the orthogonal mark can be in a state of not being present on the top surface section. Thus, it is possible to reduce the possibility of inadvertent contamination of the orthogonal mark.

A recording device according to a fourth aspect of the present disclosure is an aspect according to the third aspect, wherein the sheet-shaped member is a medium setting jig used when setting a tip end section of the medium in the transport path and the medium setting jig is a configuration of a single sheet folded in two to create a first surface and a second surface, is used in a state where the tip end section of the medium is interposed between the first surface and the second surface, and is provided with the orthogonal mark on the first surface or on the second surface.

According to this aspect, the sheet-shaped member is a medium setting jig used when the tip end section of the medium is set in the transport path. By this, since the existing medium setting jig is also used as the sheet-shaped member to which the orthogonal mark is appended, it is possible to suppress an increase in the number of components.

A recording device according to a fifth aspect of the present disclosure is an aspect according to the first aspect, wherein the feed out section includes a support shaft that supports the roll body so as to be able to be fed out and the winding shaft positioned by the positioning section is parallel to the support shaft.

Note that this aspect may be an aspect according to any one of the second aspect to the fourth aspect.

In this aspect, the winding shaft positioned by the positioning section on the top surface section is parallel to the support shaft that supports the roll body in a feedable manner. By this, since the orthogonal mark is in a state of being orthogonal to both the axial direction of the winding shaft that was positioned by the positioning section and the axial direction of the support shaft that supports the roll body, it is possible to more easily perform the rewinding operation of the medium such as changing the winding shaft of the roll body.

A recording device according to a sixth aspect of the present disclosure is an aspect according to the first aspect, wherein the positioning section includes a plurality of protrusions spaced apart from each other.

Note that this aspect may be an aspect according to any one of the second aspect to the fifth aspect.

According to the aspect, since the positioning section is a plurality of protrusions disposed separated from each other, it is possible to easily provide the positioning section.

A recording device according to a seventh aspect of the present disclosure is an aspect according to the first aspect, in which the positioning section is a single rod body.

Note that this aspect may be an aspect according to any one of the second aspect to the fifth aspect.

According to the aspect, since the positioning section is a single rod body, handling, such as installation on the top surface section, is easy.

A recording device according to an eighth aspect of the present disclosure is an aspect according to the first aspect, wherein the positioning section is attachable to and detachable from the top surface section.

This aspect may be an aspect according to any one of the second aspect to the seventh aspect.

According to the aspect, since the positioning section is attachable to and detachable from the top surface section, the positioning section can be installed on the top surface section only when a rewinding operation of the medium is performed and can be in a state of not being present on the top surface section in other cases. Therefore, it is possible to reduce a concern of inadvertent contamination.

A recording device according to a ninth aspect of the present disclosure is an aspect according to the first aspect, wherein the positioning section is provided integrally with the top surface section.

This aspect may be an aspect according to any one of the second aspect to the seventh aspect.

According to this aspect, since the positioning section is provided integrally with the top surface section, the rewinding operation of the medium can be performed at any time.

### Embodiments

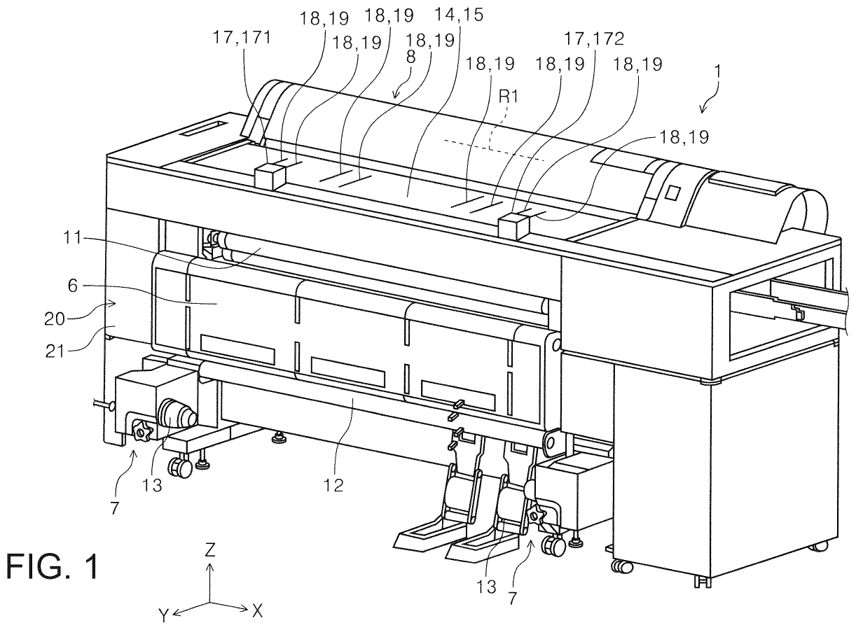

Hereinafter, embodiments of a recording device according to the present disclosure will be described with reference to FIGS. 1 to 9.

In the following description, three axes orthogonal to each other are referred to as an X-axis, a Y-axis, and a Z-axis, as shown in the drawings. The direction indicated by an arrow of the three axes (X, Y, Z) is the positive direction for each direction, and the opposite is the negative direction. The Z-axial direction corresponds to the vertical direction, that is, the direction in which gravity acts, a +Z direction indicates the vertically upward direction, and a −Z direction indicates the vertically downward direction. The X-axial direction and the Y-axial direction correspond to horizontal directions. The +Y direction indicates the front direction of the recording device, and the −Y direction indicates the rear direction of the device. A +X direction indicates the right direction of the device, and a −X direction indicates the left direction of the device.

### BRIEF DESCRIPTION OF RECORDING DEVICE

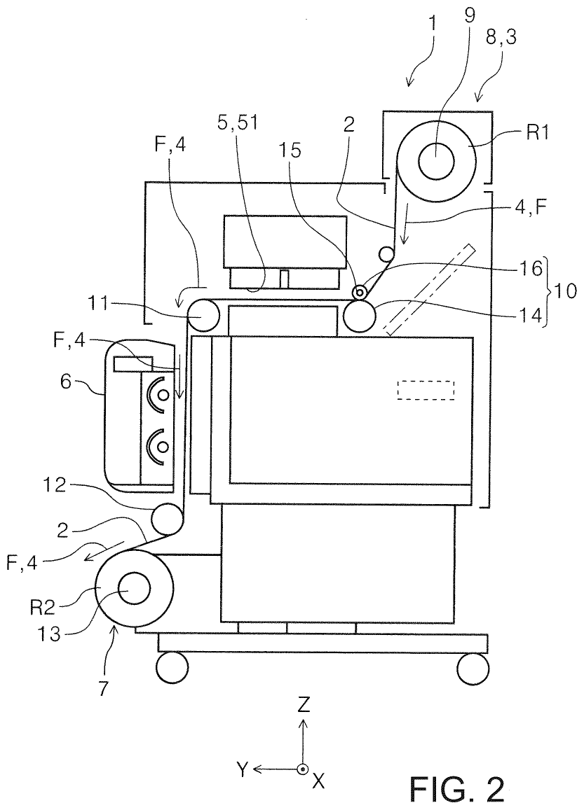

As shown in FIGS. 1 and 2, a recording device 1 of the present embodiment is a so-called digital textile printing machine in which a medium 2 to be recorded on is a fabric. The medium 2 is transported in a transport direction F in a transport path 4 by a medium transport device 3. In recording device 1, an appropriate tension is applied to the medium 2 in a transport method called roll-to-reel transport method, and a recording execution region of a recording section 51, which serves as a process section 5, is disposed in the transport path 4 in a suspended state. After being recorded by the recording section 51, the medium 2 is heated and dried by the heating section 6 disposed along the transport path 4, and is then wound by the winding section 7. Here, the recording section 51 is a serial type that is mounted on a carriage (not shown) and that reciprocates in a width direction (X-axial direction), which intersects the transport direction F. The recording section 51 is not limited to a serial type, and may be a line head.

In the present specification, the term “fabric” is used to mean not only a woven fabric made by crossing warps and wefts, but also a knitted fabric made by forming a loop with one yarn and entangling the loop with an adjacent loop, a nonwoven fabric made by entangling or bonding fibers, and the like.

As illustrated in FIG. 2, in the present embodiment, a roll body R1 of the medium 2 is rotatably supported by a support shaft 9, which is a feed out shaft of a feed out section 8. The medium 2 fed out from the roll body R1 by the medium transport device 3 is transported by a transport roller pair 10 and an intermediate roller 11 constituting the transport path 4 so as to pass by the recording execution region of the recording section 51. The medium 2 on which recording was performed by the recording section 51 is further transported by the intermediate roller 11 and a guide bar 12 through the heating region of the heating section 6. The medium 2 that has passed by the guide bar 12 is wound around a roll body R2 supported by the winding shaft 13 of the winding section 7. The winding shaft 13 is driven and rotated by rotational power transmitted from a drive source (not shown), and rotates the roll body R2 in a winding direction.

### First Embodiment

A recording device 1 according to a first embodiment of the present disclosure will be described below with reference to FIGS. 1 to 5. The recording device 1 according to the embodiment includes the feed out section 8 that feeds medium from the roll body R1, the medium transport device 3 that transports the medium 2 fed out from the feed out section 8 in a transport direction F, the recording section 51 that performs recording on the medium 2 transported by the medium transport device 3, and a housing, that is, an exterior 15 that accommodates the recording section 51 and the medium transport device 3 and that has a flat top surface section 14.

The top surface section 14 is configured to enable placement thereon of the winding shaft 16 in order to wind the medium 2. The winding shaft 16 is a paper tube made of paper having a cylindrical shape. The winding shaft 16 is not limited to a paper tube made of paper, and may be made of synthetic resin, metal, or the like. Further, the top surface section 14 includes a positioning section 17. The positioning section 17 is configured to determine a placement position for performing a rewinding operation of the winding shaft 16 by placing the winding shaft 16 in contact with the positioning section 17. Further, orthogonal marks 18 are provided on the top surface section 14. The orthogonal marks 18 are formed by straight lines 19 indicating a direction L2, which is orthogonal to the axial direction L1 of the winding shaft 16 that is being positioned by the positioning section 17. The straight lines 19 forming the orthogonal marks 18 are provided at a plurality of different positions in consideration of the type of the width of the medium 2.

Here, the term “flat” in “the exterior 15 having the flat top surface section 14” is used in this specification to mean that the exterior 15 is flat to such an extent that the medium 2 can be wound around the winding shaft 16 in a state where the winding shaft 16 is placed on the top surface section 14.

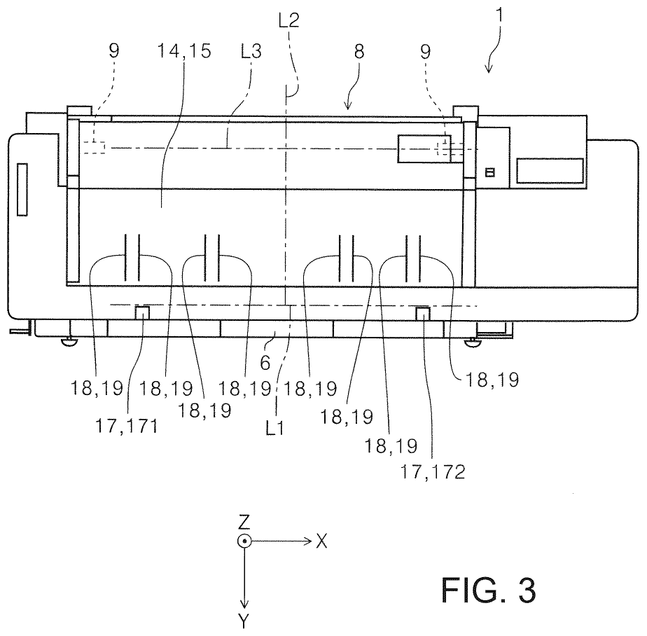

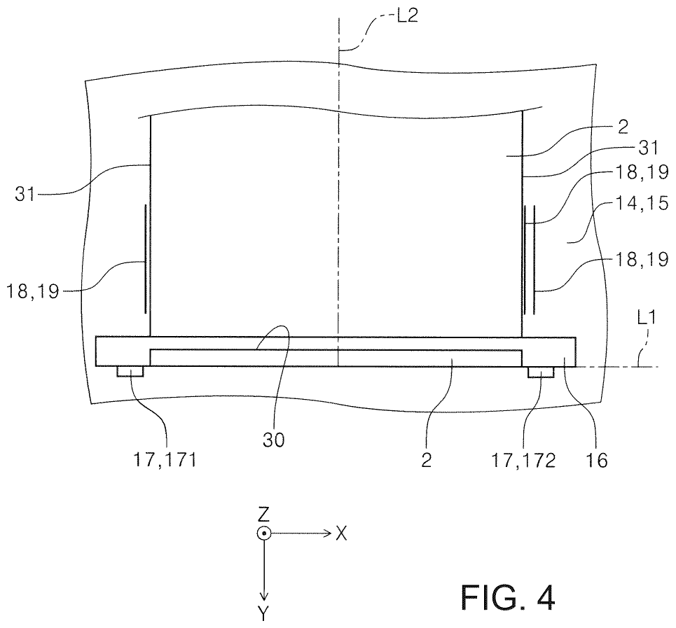

As shown in FIG. 1, FIG. 3, and FIG. 4, in the present embodiment, the positioning section 17 is constituted by a plurality of protrusions, here, two protrusions 171 and 172, which are arranged spaced apart from each other. Note that the number of the positioning sections 17 is not limited to two.

In the present embodiment, the protrusions 171 and 172 are cubes having substantially the same size, and are detachably attached to the top surface section 14. As a structure in which the protrusions 171 and 172 can be attached and detached, a configuration is adopted in which a foot portion (not shown) positioned at a lower portion of the protrusions 171 and 172 is inserted into an insertion hole (not shown) provided in the top surface section 14. It should be noted that the protrusions 171 and 172 are not limited to the above-described cubic shape, and for example, a portion which comes into contact with the winding shaft 16 may be formed of a convex curved surface.

Note that the structure in which the protrusions 171 and 172 are detachable from the top surface section 14 is not limited to the above-described insertion structure. For example, it may be attached to the top surface section using the magnetic force of a magnet, or may be attached to the top surface section by snap-fitting.

The protruding length of the protrusions 171 and 172 from the top surface section 14, that is, the height position of the portion that contacts the winding shaft 16, is preferably set to be in a range of about 25% to 50% with respect to the diameter dimension of the outer periphery of the winding shaft 16. For example, when the winding shaft 16 has a diameter of 82 mm, the height of the protrusions 171 and 172 is preferably set to be equal to or larger than 20 mm, which is about 25%. By this, the winding shaft 16 can be suppressed from becoming unstable during the winding operation. By setting the upper limit to 50%, most of the winding shaft 16 is in a state of being open to the access of the user, and the winding operation is easily performed.

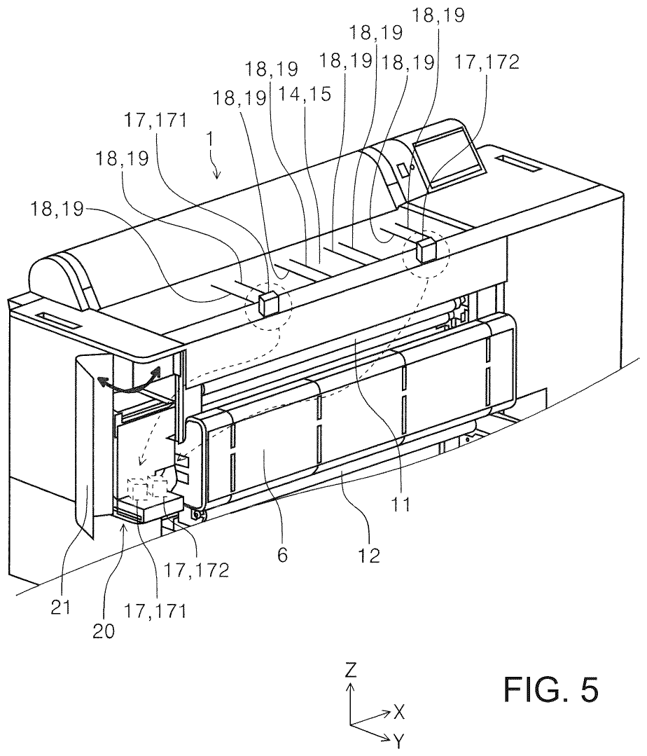

As shown in FIG. 5, in the present embodiment, the recording device 1 includes a storage section 20 that stores the protrusions 171 and 172 that were detached from the top surface section 14. When the protrusions 171 and 172 are to be used, the cover 21 of the storage section 20 is opened, and the protrusions 171 and 172 are taken out and attached to insertion holes in the top surface section 14.

As described above, the feed out section 8 includes the support shafts 9, 9 that support the roll body R1 so that the roll body can be fed out. That is, the roll body R1 is supported at both ends in the longitudinal direction by the support sections 9, 9. The support sections 9, 9 are rotated by power transmitted from a power source (not shown), and the roll body R1 is rotated around its axis by this rotation, so that the medium 2 is fed out. The support sections 9, 9 are designed so that the transmission of power can be interrupted and so they can be manually rotated in the interrupted state.

As shown in FIGS. 3 and 4, in the present embodiment, the winding shaft 16 positioned by the positioning section 17 is configured to be parallel to the support shafts 9, 9. In other words, the protrusions 171 and 172 forming the positioning section 17 are arranged such that the axial direction L1 of the winding shaft 16 and the axial direction L3 of the support shafts 9, 9 are parallel to each other.

### First Description of Rewinding Operation of First Embodiment

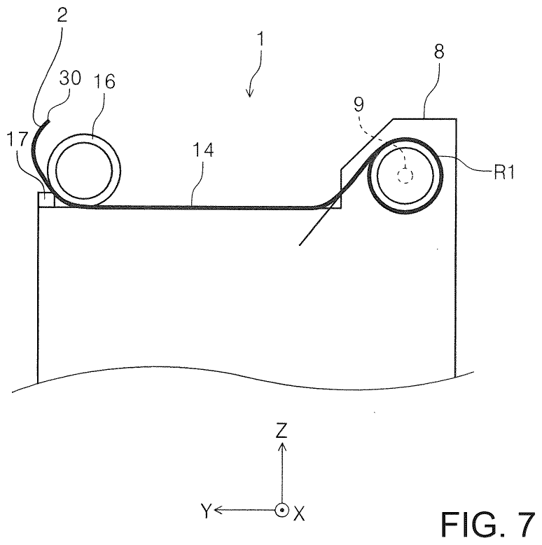

The rewinding operation of the medium 2 will be described with reference to FIG. 7. FIG. 7 illustrates a case where the medium 2 of the roll body R1 that is being supported by the support sections 9, 9 of the feed out section 8 is rewound around a new winding shaft 16.

(1) First, a user places the winding shaft 16 on the top surface section 14 in a state of being in contact with the positioning section 17.

(2) The tip end 30 of the medium 2 wound on the roll body R1 is pulled out and passed under the winding shaft 16 to be in the state shown in FIG. 7. Note that the order of (1) and (2) may be reversed.

(3) In the state shown in FIG. 7, the tip end 30 of the medium 2 is fixed to the outer peripheral surface of the winding shaft 16 with tape or the like to obtain the state shown in FIG. 4. During this procedure, the position of medium 2 is adjusted so that the edges 31 of the medium 2 extend along the orthogonal marks 18, and then the medium 2 is fixed with tape or the like.

(4) From the state shown in FIG. 4, the user performs the winding operation by rotating the winding shaft 16 in the winding direction. During this procedure, the winding shaft 16 is wound while maintaining a state in which it is in contact with the positioning section 17 and a state in which the side edges 31 of the medium 2 are aligned with the straight lines 19 of the orthogonal marks 18.

Since the axial direction L1 of the winding shaft 16 and the axial direction L3 of the support shafts 9, 9 are parallel to each other, the side edges 31 of medium 2 are hardly displaced from the state aligned with the straight lines 19 of the orthogonal marks 18, and the winding operation is facilitated.

(5) When all the medium 2 of the roll body R1 is wound around the new winding shaft 16, the winding operation is finished.

### Second Description of Rewinding Operation of First Embodiment

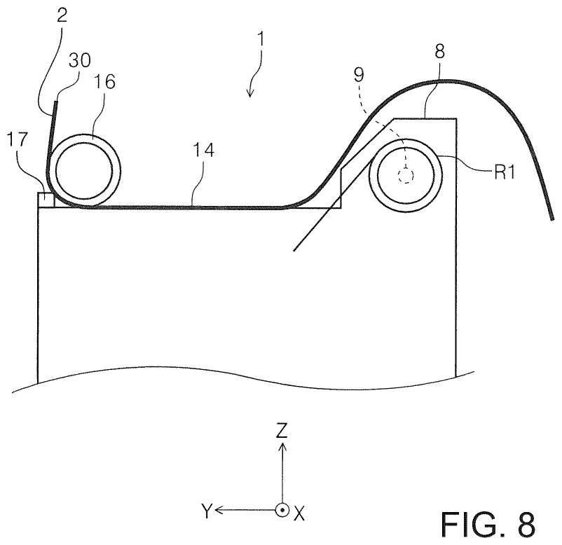

The rewinding operation of the medium 2 will be described with reference to FIG. 8. FIG. 8 illustrates a case where the medium 2 that is not wound around the roll body R1 is rewound around a new winding shaft 16.

(1) First, a user places the winding shaft 16 on the top surface section 14 in a state of being in contact with the positioning section 17.

(2) As shown in FIG. 8, the medium 2 to be wound is placed on the top surface section 14 and the feed out section 8. Then, the tip end 30 of the medium 2 is passed below the winding shaft 16 to be in the state shown in FIG. 8. Note that the order of (1) and (2) may be reversed.

(3) In the state shown in FIG. 8, the tip end 30 of the medium 2 is fixed to the outer peripheral surface of the winding shaft 16 with tape or the like to obtain the state shown in FIG. 4. During this procedure, the position of medium 2 is adjusted so that the edges 31 of the medium 2 extend along the orthogonal marks 18, and then the medium 2 is fixed with tape or the like.

(4) From the state shown in FIG. 4, the user performs the winding operation by rotating the winding shaft 16 in the winding direction. During this procedure, the winding shaft 16 is wound while maintaining a state in which it is in contact with the positioning section 17 and a state in which the side edges 31 of the medium 2 are aligned with the straight lines 19 of the orthogonal marks 18.

(5) When the entire medium 2 is wound around the new winding shaft 16, the winding operation is finished.

### Explanation of Effects of First Embodiment

(1) In this embodiment, since the top surface section 14 forming the exterior 15 of the recording device 1 has a structure with a flat portion, a winding shaft 16 for winding the medium 2 can be placed on it. By this, it is possible to perform the rewinding operation of the medium 2, such as correcting an initial winding deviation of the medium 2 in the roll body state or changing the winding shaft 16 of the roll body, by using the top surface section 14, which forms a part of the exterior 15.

Further, the top surface section 14 is provided with a positioning section 17 for determining the placement position of the winding shaft 16 by placing the winding shaft 16 on the top surface section 14 in contact with the positioning section 17. By this, by placing the winding shaft 16 so as to contact the positioning section 17 when the winding shaft 16 is placed on the top surface section 14, the winding shaft 16 can be easily placed at a position where the winding operation of the medium 2 is to be performed. Furthermore, since the winding shaft 16 is placed on the top surface section 14 in a state of being in contact with the positioning section 17, the position of the winding shaft 16 during the rewinding operation of medium 2 is stabilized, and the rewinding operation is easily performed.

Further, the recording device 1 includes the orthogonal marks 18 indicating the direction orthogonal to the axial direction L1 of the winding shaft 16 positioned by the positioning section 17. By this, when the tip end 30 of the medium 2 is attached and fixed to the winding shaft 16 that was positioned by the positioning section 17, the parallel state between the orthogonal marks 18 and the side edges 31 of the medium 2 can be confirmed, and thus the fixing work can be easily performed in an appropriate state. Further, when the winding shaft 16 after being fixed is rotated to perform the rewinding operation of the medium 2, it is possible to wind the medium 2 while adjusting the side edges 31 of the medium 2 to be parallel to the orthogonal marks 18. Therefore, it is possible to reduce the possibility that the state of the end of the medium 2 after rewinding will be irregular, that is, will be uneven.

(2) In the present embodiment, the orthogonal mark 18 is provided on the top surface section 14. By this, when the user places the winding shaft 16 on the top surface section 14, the user can position the winding shaft 16 by bringing it into contact with the positioning section 17 while checking the orthogonal mark 18.

(3) In the present embodiment, the winding shaft 16 positioned by the positioning section 17 on the top surface section 14 is parallel to the support shafts 9, 9 that support the roll body R1 so that the roll body can be unwound. By this, the direction L2 of the orthogonal mark 18 is in an orthogonal state with respect to both the axial direction L1 of the winding shaft 16 positioned by the positioning section 17 and the axial direction L3 of the support shafts 9, 9 supporting the roll body R1, so that the rewinding operation of the medium 2, such as changing the winding shaft of the roll body R1, can be more easily performed.

(4) In the present embodiment, since the positioning section 17 is constituted by the plurality of protrusions 171 and 172 arranged separated from each other, the positioning section 17 can be easily provided.

(5) In this embodiment, since the positioning section 17 can be attached to and detached from the top surface section 14, the positioning section 17 can be installed on the top surface section 14 only when the rewinding operation of medium 2 is performed, and can be absent from the top surface section 14 at other times. Therefore, it is possible to reduce the risk of inadvertent contamination.

### First Modification of First Embodiment

In the above description of the first embodiment, the positioning section 17 is constituted by the plurality of protrusions 171 and 172 arranged to be spaced apart from each other. However, the positioning section 17 is not limited to the structure formed by the protrusions 171 and 172.

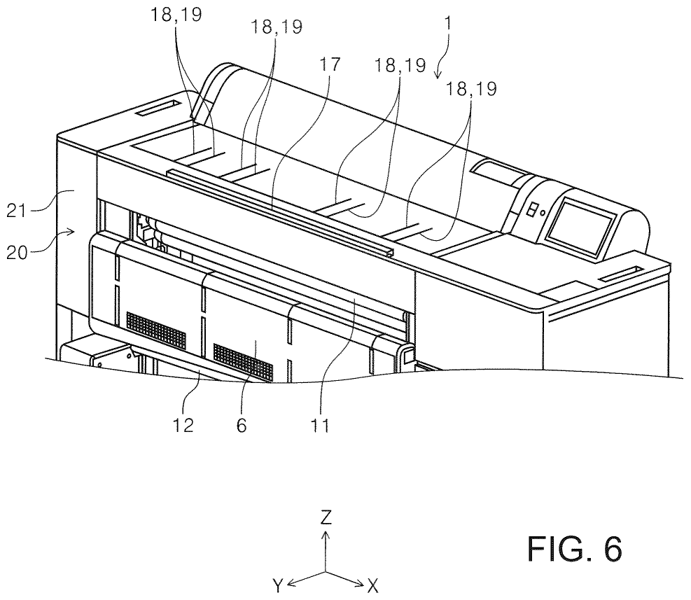

For example, as shown in FIG. 6, the positioning section 17 may be formed of a single rod body. The positioning section 17 formed by this rod body has an elongated rectangular parallelepiped shape and is formed to have a uniform thickness in the longitudinal direction. The positioning section 17 has a foot portion (not shown) similar to that of the protrusions 171 and 172, and a structure in which the foot portion is inserted into an insertion hole is adopted.

According to the present modification, since the positioning section 17 is a single rod body, handling, such as installation on the top surface section 14, is easy.

### Second Modification of First Embodiment

In the description of the first embodiment provided above, although the positioning section 17 is described as being attachable to and detachable from the top surface section 14, the positioning section 17 may also be of a structure that is integrally provided on the top surface section 14.

In the case of this structure, it is desirable that the positioning section 17 can be switched between a protruding state in which the positioning section 17 protrudes from the top surface section 14 and a retracted state in which the positioning section 17 does not protrude from the top surface section 14.

According to the present modification, since the positioning section 17 is provided integrally with the top surface section 14, the rewinding operation of the medium 2 can be performed at any time.

### Second Embodiment

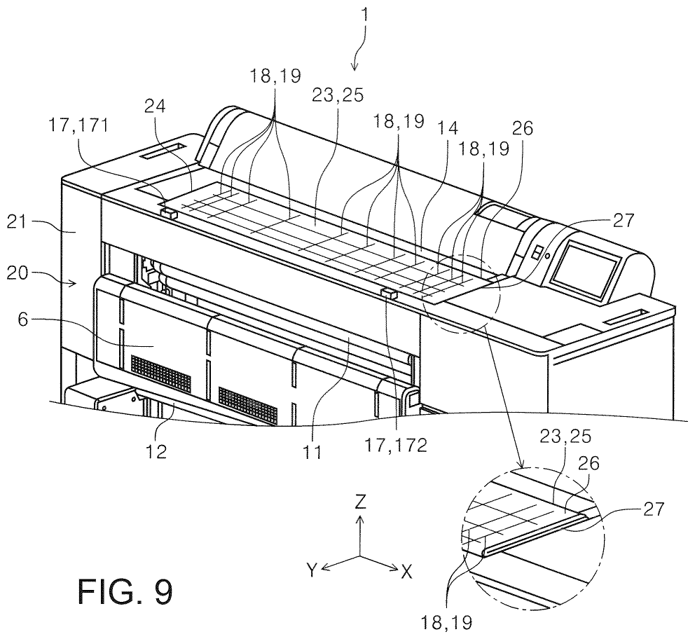

Next, a recording device 1 according to a second embodiment will be described with reference to FIG. 9. The same parts as those in the first embodiment are denoted by the same reference numerals, and the description of the configuration and the corresponding effects will be omitted.

As shown in FIG. 9, in the present embodiment, the orthogonal mark 18 is provided on a sheet-shaped member 23. The sheet-shaped member 23 is configured such that by placing the sheet-shaped member 23 at the placing position 24 of the top surface section 14, the orthogonal mark 18 is orthogonal to the axial direction of the winding shaft 16 positioned by the positioning section 17. The placing position 24 is appended with a mark or the like (not shown) on the top surface section 14 so that the user can easily place it at that position.

The sheet-shaped member 23 placed at the placing position 24 is fixed by a position fixing member (not shown) so as not to be accidentally displaced. Here, a detachable positioning section 17 is used for the position fixing member. That is, the sheet-shaped member 23 is configured to be pressed to be positionally fixed at the time of attaching the positioning section 17 to the top surface section. The position fixing member is not limited to the structure that uses the positioning section 17, and any member may be used as long as the member can be fixed so as not to be unintentionally displaced. For example, the sheet-shaped member 23 may be fixed to the placing position 24 by a magnet, an insertion pin, or the like.

In the present embodiment, the sheet-shaped member 23 uses a medium setting jig 25 that is used when the end section, including the tip end 30, of the medium 2 is pulled out from the roll body R1 and set in the transport path 4.

As shown in a partially enlarged view in FIG. 9, the medium setting jig 25 has a structure in which one sheet is folded in two so that a first surface 26 and a second surface 27 are formed. The medium setting jig 25 is used in a state where the end section including the tip end 30 of the medium 2 is interposed between the first surface 26 and the second surface 27.

When the rigidity of medium 2 is low, it may be difficult to insert the end section of the medium 2 through the transport path 4 from the rear (−Y side) to the front (+Y side) of the recording section 51 as shown in FIG. 2. The medium setting jig 25 is such that when such a medium 2 is set in the transport path 4, the medium setting jig 25 compensates for the low rigidity to facilitate setting. That is, as shown in a partially enlarged view in FIG. 9, by sandwiching the tip end section of the medium 2 between the first surface 26 and the second surface 27, the low rigidity is compensated for, and the setting of the tip end section of the medium 2 through the transport path 4 is easily performed.

In the present embodiment, the orthogonal mark 18 is provided on the first surface 26. The orthogonal mark 18 may be provided on the second surface 27.

In this embodiment, the orthogonal mark 18 is not directly provided on the top surface section 14, but is provided on the sheet-shaped member 23. Further, by placing the sheet-shaped member 23 at the placing position 24 of the top surface section 14, the orthogonal mark 18 becomes orthogonal to the axial direction L1 of the winding shaft 16 that was positioned by the positioning section 17.

By this, the orthogonal mark 18 is present on the top surface section 14 only when the winding operation is performed, and at other times, the orthogonal mark 18 is not present on the top surface section 14. This can reduce the risk of inadvertent contamination of the orthogonal mark 18.

In the embodiment, the sheet-shaped member 23 is a medium setting jig 25, which is used when the tip end section of medium 2 is set in the transport path 4.

By this, since the existing medium setting jig 25 is also used as the sheet-shaped member 23 to which the orthogonal mark 18 is appended, it is possible to suppress an increase in the number of components.

### Other Embodiments

The recording device 1 according to the present disclosure basically has the configuration of the embodiments described above, but it is of course possible to change or omit a partial configuration without departing from the gist of the present disclosure.

What is claimed is:

1. A recording device comprising:
a feed out section configured to feed out a medium from a roll body;
a medium transport device configured to transport, in a transport direction, the medium fed from the feed out section;
a recording section configured to record on the medium transported by the medium transport device; and
an exterior that houses the recording section and the medium transport device and that has a flat top surface section, wherein
the top surface section
is configured to have placed thereon a winding shaft for winding the medium,
includes a positioning section configured to determine a placement position of the winding shaft by the winding shaft being placed in contact with the positioning section, and
includes an orthogonal mark indicating a direction orthogonal to an axial direction of the winding shaft positioned by the positioning section.

2. The medium transport device according to claim 1, wherein
the orthogonal mark is provided on the top surface section.

3. The medium transport device according to claim 1, wherein
the orthogonal mark is provided on a sheet-shaped member and
by the sheet-shaped member being placed at a placing position of the top surface section, the orthogonal mark becomes orthogonal to the axial direction of the winding shaft positioned by the positioning section.

4. The medium transport device according to claim 3, wherein
the sheet-shaped member is a medium setting jig used when setting a tip end section of the medium in the transport path and
the medium setting jig
is a configuration of a single sheet folded in two to create a first surface and a second surface,
is used in a state where the tip end section of the medium is interposed between the first surface and the second surface, and
is provided with the orthogonal mark on the first surface or on the second surface.

5. The medium transport device according to claim 1, wherein
the feed out section includes a support shaft that supports the roll body so as to be able to be fed out and
the winding shaft positioned by the positioning section is parallel to the support shaft.

6. The medium transport device according to claim 1, wherein
the positioning section includes a plurality of protrusions spaced apart from each other.

7. The medium transport device according to claim 1, wherein
the positioning section is a single rod body.

8. The medium transport device according to claim 1, wherein
the positioning section is attachable to and detachable from the top surface section.

9. The medium transport device according to claim 1, wherein
the positioning section is provided integrally with the top surface section.
